(19) United States
(12) Patent Application Publication
(10) Pub. No.: US 2016/0018857 A1
(43) Pub. Date: Jan. 21, 2016

(54) APPARATUS HAVING COVER OR ALTERNATIVELY EXTENSION UNIT

(71) Applicant: Kabushiki Kaisha Toshiba, Tokyo (JP)

(72) Inventor: Kiyoshi Kawabe, Ome Tokyo (JP)

(21) Appl. No.: 14/603,172

(22) Filed: Jan. 22, 2015

Related U.S. Application Data
(60) Provisional application No. 62/026,493, filed on Jul. 18, 2014.

(51) Int. Cl. G06F 1/18

(52) U.S. Cl. CPC G06F 1/181

(57) ABSTRACT

According to one embodiment, an apparatus includes a case and a cover. The case contains a device having a terminal for additionally connecting at least one function. The case includes at least one opening portion and a mount. The mount is provided to allow a module to be attached to an outside of the opening portion, the module being connected to the device through the terminal to operate. The cover is attached to the mount and covers the opening portion.

### CROSS-REFERENCE TO RELATED APPLICATIONS

This application claims the benefit of U.S. Provisional Application No. 62/026,493, filed Jul. 18, 2014, the entire contents of which are incorporated herein by reference.

### FIELD

Embodiments described herein relate generally to an apparatus having a cover or alternatively an extension unit.

### BACKGROUND

In an apparatus designed in advance to allow an extension unit to be added as an option, room for incorporating the extension unit as the option is prepared in a housing. So far, extension units have been selected by a user and have been built in the room in accordance with grades of performance and functions of the extension units. However, in an electronic apparatus, etc., as the electronic apparatus itself comes to have more functions and thus extension units come to be equipped in other forms, the extension units so far come to be less often selected by users. As a result, room for the extension unit is nothing more than useless room, for a user who does not require an extension unit. The external size of the apparatus became small by excluding room for the extension unit. Thus, more and more users who request an apparatus having external size became small by excluding room for an extension unit is increased. On the other hand, the user who requests an extension unit not included as a standard function of the electronic apparatus is not few either. To meet the both requirements, the design of the housing is necessary for each, and the unit price of product become expensive. In addition, since the electronic apparatus with an extension unit is put on the market as the product, it is undesirable to equip with the extension unit on exterior in plainness as an appearance of design.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view of an apparatus of a first embodiment, and shows that a cover can be exchanged for a module;

FIG. 2 is an exploded perspective view of an apparatus of a second embodiment, and shows that a direction in which the module is attached can be changed;

FIG. 3 is an exploded perspective view of an apparatus of a third embodiment;

FIG. 4 is an exploded perspective view of an apparatus of a forth embodiment;

FIG. 5 is an exploded perspective view of an apparatus of a fifth embodiment; and

FIG. 6 is an exploded perspective view of an apparatus of a sixth embodiment.

### DETAILED DESCRIPTION

Various embodiments will be described hereinafter with reference to the accompanying drawings.

In general, according to one embodiment, an apparatus comprises a case and a cover. The case contains a device comprising a terminal for additionally connecting at least one function. This case comprises at least one opening portion and a mount. The mount is provided to allow a module to be attached to an outside of the opening portion, the module being connected to the device through the terminal to operate. The cover is attached to the mount and covers the opening portion.

Alternatively, an apparatus of another embodiment comprises a case and a module. The case contains a device comprising a terminal for additionally connecting at least one function. This case comprises at least one opening portion and a mount provided to allow a cover covering the opening portion to be attached. The module is disposed outside the case to cover the opening portion by means of the mount, and is connected to the device through the terminal to operate.

Since this apparatus comprises the above-described mount, a function can be added to the device contained in the case by attaching the module to an outside of the opening portion of the case instead of the cover. In addition, if the function need not be added to the contained device, that is, if a module for function expansion need not be attached, a device in which a cover is attached to a case can be provided as a device having smaller external dimensions as those in the case where the module is attached.

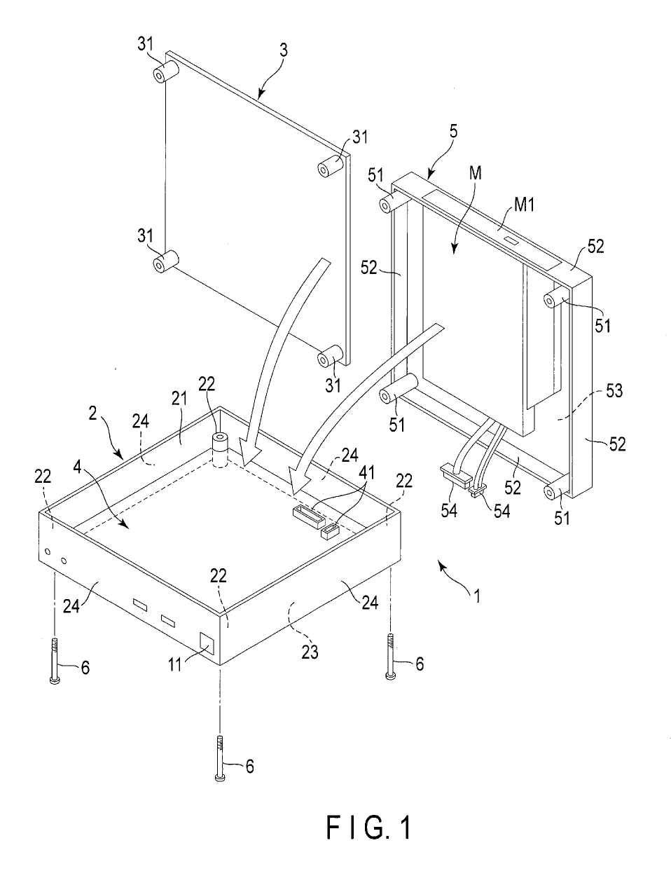

An apparatus 1 of a first embodiment will be described with reference to FIG. 1. The apparatus 1 shown in FIG. 1 comprises a case 2 and a cover 3. The case 2 contains a device 4 comprising a terminal 41 for additionally connecting at least one function. The case 2 comprises at least one opening portion 21 and mounts 22. The mounts 22 are provided, such that a module 5 connected to the device 4 through the terminal 41 to operate is disposed outside the opening portion 21. Moreover, the cover 3 is attached to the mounts 22 and covers the opening portion 21.

In this embodiment, for convenience of explanation, when a side on which a power switch 11 of the apparatus, etc., are provided is regarded as the front, a side close to a user is the front and a side distant from the user is the back. The bottom portion and the top portion are determined with respect to a side on which the apparatus 1 is settled. Also, right and left are determined from the perspective of the user.

Solid lines in FIG. 1 indicate the state where the case 2 and the cover 3 are assembled and the module 5 is not applied. Two-dot chain lines in FIG. 1 indicate the state where the cover 3 is detached from the case 2 and the module 5 is attached to the case 2 instead of the cover 3. The case 2 in this embodiment is a rectangular parallelepiped having a smaller height than a width and a depth. A top portion of the case 2 is the opening portion 21, and the mounts 22 are provided at a deeper position in the case 2 than the opening portion 21.

As indicated by the two-dot chain lines in FIG. 1, the cover 3 comprises stems 31 abutting the mounts 22. The module 5 indicated by the solid lines in FIG. 1 also comprises stems 51 having the same shape as those of the stems 31 of the cover 3. The cover 3 or the module 5 is fixed by screwing bolts 6 passed through the mounts 22 from the side of a bottom portion 23 of the case 2 into the stems 31 or the stems 51.

In the present embodiment, the case 2 comprises outer peripheral surfaces 24 adjacent to the opening portion 21, and the module 5 comprises outer peripheral walls 52 formed to be substantially flush with the outer peripheral surfaces 24, and a top wall 53 covering the opening portion 21 as the cover 3. The module 5 contains an optical disk drive (ODD) unit M. A tray M1 of the ODD unit M is formed to be drawn out from one of the outer peripheral walls 52 of the module 5. In FIG. 1, as indicated by the two-dot chain lines, the module 5 is attached to the case 2, such that the tray M1 is opened in front of the case 2. The ODD unit M comprises a connector 54 connected to the terminal 41 of the device 4 contained in the case 2. The terminal 41 and the connector 54 connect a control signal line with a power supply line. Operation of the ODD unit M is thereby controlled.

As the module 5 connected to the terminal 41 of the device 4 contained in the case 2 through the connector 54, except for the ODD unit M, a hard-disk drive (HDD) unit, a solid-state drive (SSD) unit, or a daughterboard such as a graphics board may be used. In addition, not only the foregoing but other things may be used, as long as they expand a function of the device 4.

According to the apparatus of the first embodiment configured as described above, the apparatus 1 having a simple and compact structure in which the cover 3 is attached to the case 2 as indicated by the solid lines in FIG. 1 can be provided to a user who does not require the module 5 such as the ODD unit M as an option. In addition, the apparatus 1 having a structure in which the module 5 is attached to the case 2 instead of the cover 3 as indicated by the two-dot chain lines in FIG. 1 can be provided to a user who requires the module 5 for function expansion such as the ODD unit M as an option.

In the apparatus 1 including the module 5, the ODD unit M is disposed outside the opening portion, and thus, the external dimensions thereof are larger than those of the apparatus 1 in which the cover 3 is attached. However, because the case 2 has the same structure of the case 2 and the same function of the device 4 to be mounted, manufacturing lines can be unified, and manufacturing costs can be reduced. In addition, by selling the cover 3 and the module 5 separately, if a user who bought the apparatus 1 incorporating the module 5 stops needing the ODD unit M, the external dimensions of the apparatus 1 can be made smaller by replacement by the cover 3. Contrary to this, if a user who bought the apparatus 1 not incorporating the module 5 comes to need the ODD unit M, it is not externally connected through a cable, but the cover 3 is replaced by the module 5, and thus, the module 5 can be integrally incorporated as one of functions of the device 4. Because there are no redundant cables around the apparatus 1, it is pleasing in appearance.

Hereinafter, apparatuses 1 of second to sixth embodiments will be described. In each of the embodiments, a structure having the same function as that of a structure included in the apparatus 1 of the first embodiment will be given the same sign in the following description and the drawings, and regarding detailed explanations thereof, the description concerning the first embodiment should be referred to.

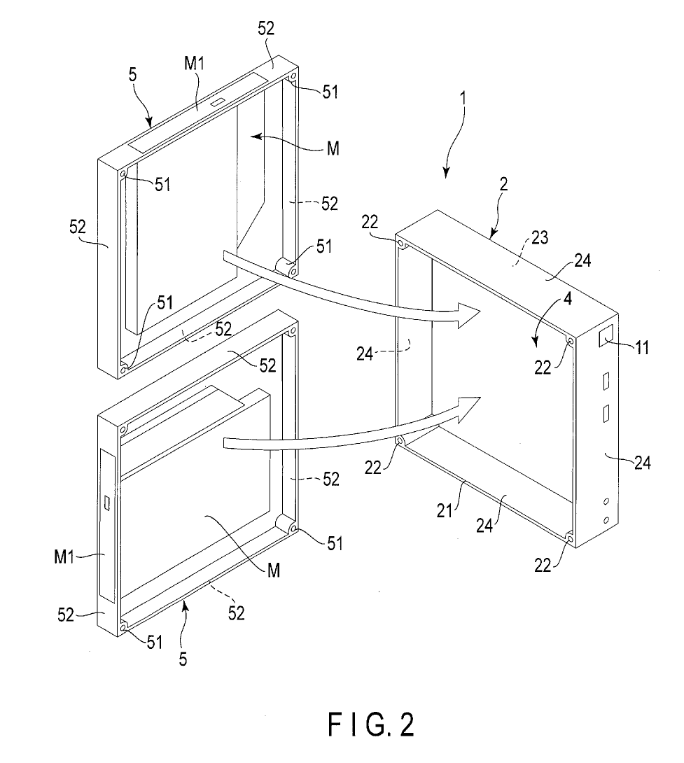

The apparatus 1 of the second embodiment will be described with reference to FIG. 2. In this apparatus 1, outer peripheral surfaces 24 of a case 2 adjacent to an opening portion 21 are formed in n-fold rotational symmetry with respect to a center line vertically passing through the opening portion 21 as shown in FIG. 2. In the present embodiment, the outer peripheral surfaces 24 are in 4-fold rotational symmetry and have the shape of prisms along four sides of a square. A module 5 comprises outer peripheral walls 52 corresponding to the outer peripheral surfaces 24 of the case 2 in n-fold rotational symmetry, that is, in 4-fold rotational symmetry as shown in FIG. 2 in the present embodiment. In the present embodiment, the opening portion 21 of the case 2 is laterally directed and is in a so-called upright state, having a small width and a large height from the perspective of the front.

At four corners of an inner periphery of the opening portion 21 of the case 2, mounts 22 are provided, respectively. At four corners on the inner periphery's sides of the outer peripheral walls 52 of the module 5, stems 51 are formed to correspond to the mounts 22. Thus, the module 5 can be attached to the mounts 22 by making the outer peripheral walls 52 of the module 5 conform to the outer peripheral surfaces 24 of the case 2 in 4-fold rotational symmetry.

In FIG. 2, it is assumed that the apparatus 1 is used while a bottom portion 23 of the case 2 is vertically stood. Since the outer peripheral surfaces 24 of the case 2 are in 4-fold rotational symmetry, a tray M1 of an ODD unit M of the module 5 may be drawn out in an upward direction, or a forward direction on the same side as that of a power switch 11, etc.

In this manner, the outer peripheral surfaces 24 of the case 2, the outer peripheral walls 52 of the module 5 and the mounts 22 are each formed and disposed in n-fold rotational symmetry, in 4-fold rotational symmetry in the present embodiment. Thus, in particular, in the case of the module 5 equipped with such a unit drawn out in a fixed direction as the tray M1 of the ODD unit M, a direction of attachment to the case 2 can be freely selected within a range of n-fold rotational symmetry. That is, the tray M1 of the ODD unit M can be disposed to face a direction which allows a disk to be easily loaded/drawn out in accordance with a dominant hand of a user. Therefore, the apparatus 1 which can be easily customized in accordance with the user's request and has good operability can be provided.

In addition, it suffices, if the appearances of the case 2 and the module 5 are in n-fold rotational symmetry and the mounts 22, to which the module 5 is attached, can fix the module 5 to the case 2 in n-fold rotational symmetry. Thus, the opening portion 21 need not be in n-fold rotational symmetry. Also, if an object has the same shape n times while being rotated about the central axis, it is in n-fold rotational symmetry. Accordingly, not only a polygon of an equilateral n-gon but a rhombus, a star such as a five-pointed star, and a shape formed with curves may be applied.

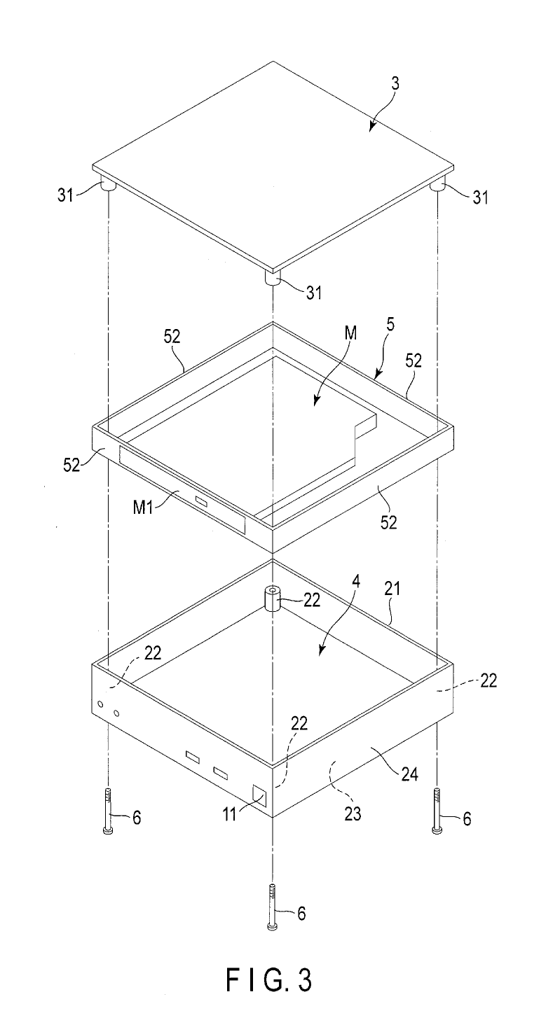

Next, the apparatus 1 of the third embodiment will be described with reference to FIG. 3. In the case of this apparatus 1, a case 2 and a cover 3 are applied to both of a user who does not require a module 5 and a user who requires the module 5. If the module 5 is incorporated, the module 5 is fixed to an opening portion 21 by fixing stems 31 of the cover 3 to mounts 22 of the case 2 in a state where the module 5 is interposed between the case 2 and the cover 3. The case 2, the cover 3 and the module 5 are integrally assembled by screwing bolts 6 passed through the mounts 22 from the side of a bottom portion 23 into the stems 31 of the cover 3. On the other hand, if the module 5 is not required, the cover 3 is fixed to the mounts 22 to cover the opening portion 21 of the case 2. Although the bolts 6 having lengths differing between the cases of being equipped with and not being equipped with the module 5 may be used, the cases can also be met by adjusting length by which the bolts 6 are screwed into the stems 31.

The module 5 is positioned by passing the stems 31 of the cover 3 through four corners of an inner periphery of outer peripheral walls 52 of the module 5, and the cover 3 and the module 5 are fixed by screwing the bolts 6. The outer peripheral walls 52 of the module 5 facing the opening portion 21 of the case 2 may be provided with an engaging piece fitted into the opening portion 21 of the case 2. In addition, fitting portions engaging with or externally fitted into the stems 31 of the cover 3 may be provided at the four corners of the inner periphery of the outer peripheral walls 52 to enable firm fixation.

In the third embodiment, outer peripheral surfaces 24 of the case 2 and the outer peripheral walls 52 of the module 5 are formed in n-fold rotational symmetry as in the second embodiment, in 4-fold rotational symmetry in the third embodiment. Furthermore, the outer peripheral walls 52 of the module 5 disposed between the case 2 and the cover 3 are formed also in mirror symmetry. Thus, a tray M1 can be assembled into the case 2, not only selecting a direction in which the tray M1 of an ODD unit M is drawn out but also reversing a direction of a mounting face of the tray M1 on which a disk is placed.

In other words, the degree of freedom for meeting a user's request is increased. Because a direction in which the module 5 is assembled can be freely selected in the state where the ODD unit M is attached to the outer peripheral walls 52 of the module 5, assembly work is also easy. Moreover, the external dimensions of the apparatus 1 in which the module 5 incorporated as an expanded function is removed and the case 2 and the cover 3 are combined are reduced by those of the module 5 disposed outside the opening portion 21. The apparatus 1 which is simple and compact can be provided to a user who does not require the module 5 as an expanded function, and the apparatus 1 of consistent design can be provided also to a user who requires the module 5, because the case 2 and the cover 3 are common parts.

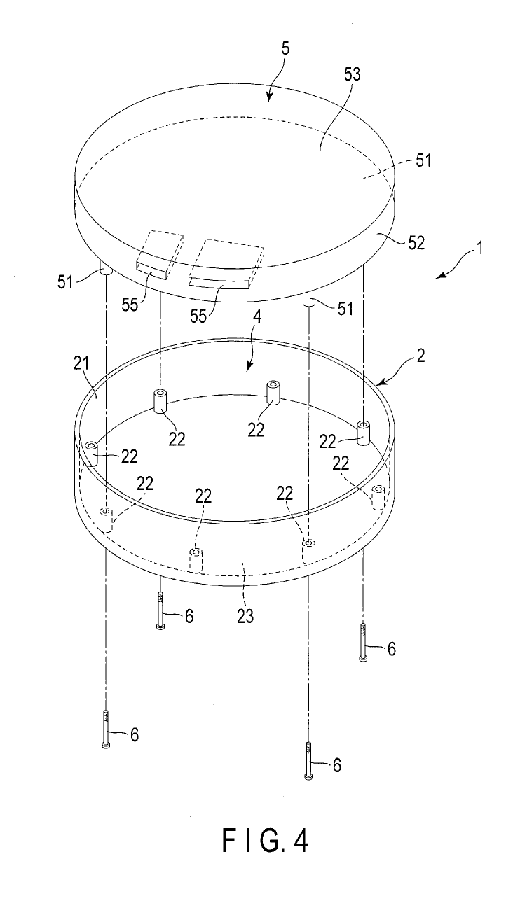

Next, the apparatus 1 of the fourth embodiment will be described with reference to FIG. 4. In the apparatus 1 shown in FIG. 4, an outer peripheral surface 24 of a case 2 and an outer peripheral wall 52 of a module 5 are cylindrical. Mounts 22 provided at the case 2 are provided at eight places in equidistribution with the pitch of 45°. Stems 51 provided at the module 5 are provided at four places in equidistribution with the pitch of 90°. Thus, in this apparatus 1, the module 5 can be attached to the case 2 in n-fold rotational symmetry, in 8-fold rotational symmetry in the fourth embodiment.

In the case of the apparatus of FIG. 4, the module 5 comprises a slot 55 into which a storage medium such as a memory card can be inserted. In addition, to provide the apparatus 1 having a small external shape to a user who does not require a function of the module 5, a discoid cover 3 covering an opening portion 21 of the case 2 may be mounted as in the first embodiment. Furthermore, as in the third embodiment, the cover 3 may be provided in both of the cases of being equipped with and not being equipped with the module 5. In those cases, the module 5 is formed in mirror symmetry. Moreover, if the module 5 is positioned with respect to the case 2 by stems 31 of the cover 3, it may be set at any angles as long as structural parts of the module 5 do not interfere with the stems 31. To safely wire a wire connected to a connector 54, etc., fitting pieces may be provided inside the module 5 to fix the module 5 to the stems 31 at a fixed rotational position.

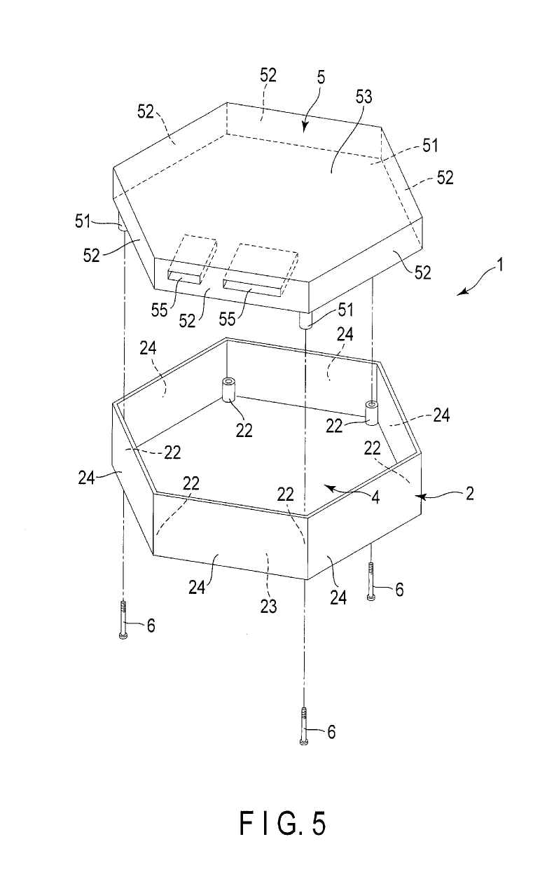

Next, the apparatus 1 of the fifth embodiment will be described with reference to FIG. 5. In the apparatus 1 shown in FIG. 5, outer peripheral surfaces 24 of a case 2 and outer peripheral walls 52 of a module 5 are formed in a regular hexagonal prism. Mounts 22 comprised at the case 2 are provided at six places in equidistribution with the pitch of 60°. Stems 51 comprised at the module 5 are provided at three places in equidistribution with the pitch of 120°. The stems 51 provided at the module 5 may also be provided at four places corresponding to four corners of any pair of opposite sides of a hexagon. In this apparatus 1, the module 5 can be attached to the case 2 in n-fold rotational symmetry, in 6-fold rotational symmetry in the fifth embodiment.

The apparatus 1 may be equipped with a regular hexagonal cover 3 covering an opening portion 21 of the case 2 instead of the module 5 as in the first embodiment. In addition, as in the third embodiment, by forming the module 5 in mirror symmetry, the cover 3 may be provided in both of the cases of being equipped with and not being equipped with the module 5.

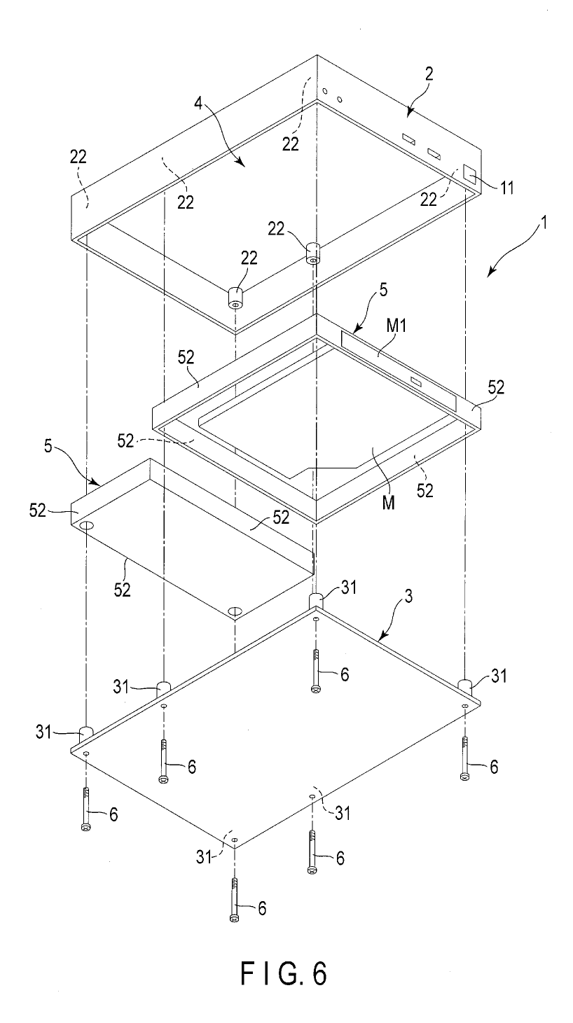

Next, the apparatus 1 of the sixth embodiment will be described with reference to FIG. 6. The apparatus 1 shown in FIG. 6 is in the state of being viewed upward from a lower side to be a mounding face, and comprises a case 2 of a rectangular parallelepiped and a cover 3 having an external shape along outer peripheral surfaces 24 of the case 2. The case 2 of the present embodiment comprises an opening portion 21 on a side which is at the bottom when the apparatus 1 is settled, and the cover 3 is mounted to cover the opening portion 21. Bolts 6 are mounted from the side of the cover 3 so as not to spoil the design for the appearance of the apparatus 1. Between the case 2 and the cover 3, two modules 5 are interposed and fixed. At this time, the cover 3 is fixed to mounts 22 to allow at least one of the modules 5 to be sandwiched in n-fold rotational symmetry between the case 2 and the cover 3.

More specifically, one of the modules 5 is an ODD unit M and is formed in n-fold rotational symmetry, in 4-fold rotational symmetry in this case, and in mirror symmetry. The other of the modules 5 may be an additional memory, an SSD, an HDD, a unit comprising various connectors, or a daughterboard. Alternatively, it may be an uninterrupted power supply unit equipped with a battery. This module 5 need not be provided in n-fold rotational symmetry if it has no projection on outer peripheral surfaces 52.

By virtue of the above-described structure, when the apparatus 1 is additionally equipped with a module 5 in accordance with a user's request, a direction in which a tray M1 of the ODD unit M can be set at one of a forward direction, a right direction and a left direction. In addition, the case 2 and the cover 3 are used in both situations of being equipped with and not being equipped with the module 5. Moreover, to a user who does not require the modules 5, the apparatus 1 having small external dimensions can be provided without changing the designs of the case 2 and the cover 3.

In the second to sixth embodiments, a device 4 and a terminal 41 provided inside a case 2 and a connector 54 which extends from a unit provided at a module 5 and is connected to the terminal are omitted from each of the figures, but are provided as in the first embodiment.

In addition, a unit incorporated into a module 5 may be any thing as long as it is connected to a device 4 mounted on a case 2 through a terminal 41 to operate and expands a function of the device 4. Thus, it is not limited to a module such as a peripheral device additionally attached to an electronic device. For example, in order to execute integrated control over household electrical appliances disposed in certain living space, it may be a module 5 such as a computer attached instead of a cover 3 covering an opening portion 21 provided at a case 2 of a household electrical appliance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus comprising:
a case comprising a device comprising a terminal for additionally connecting at least one function, the case comprising at least one opening portion and a mount provided to allow a module to be attached to an outside of the opening portion, the module configured to connect to the device through the terminal to operate; and
a cover attached to the mount, the cover covering the opening portion.

2. The apparatus of claim 1, wherein
the case is coupled with the module outside of the opening portion.

3. The apparatus of claim 2, wherein
the case comprises an outer peripheral surface adjacent to the opening portion, the outer peripheral surface being in n-fold rotational symmetry,
the module comprises an outer peripheral wall corresponding to the outer peripheral surface, the outer peripheral wall in n-fold rotational symmetry, and
the mount is configured to receive the module in n-fold rotational symmetry.

4. The apparatus of claim 2, wherein
the module is inserted between the case and the cover, and is fixed to the opening portion.

5. The apparatus of claim 4, wherein
the module comprises an outer peripheral wall between the case and the cover, the outer peripheral wall formed in n-fold rotational symmetry and in mirror symmetry.

6. The apparatus of claim 4, wherein
the case comprises an outer peripheral surface adjacent to the opening portion, the outer peripheral surface formed in n-fold rotational symmetry,
the module comprises an outer peripheral wall corresponding to the outer peripheral surface, the outer peripheral wall formed in n-fold rotational symmetry, and
the cover is attached to the mount to allow the module to be sandwiched in n-fold rotational symmetry between the case and the cover.

7. An apparatus comprising:
a case comprising a device comprising a terminal for additionally connecting at least one function, the case comprising at least one opening portion and a mount provided to allow a cover covering the opening portion to be attached; and
a module disposed outside the case to cover the opening portion by using the mount, the module configured to connect to the device through the terminal to be operated.

8. The apparatus of claim 7, wherein
the case is coupled with the cover at the opening portion.

9. The apparatus of claim 7, wherein
the case comprises an outer peripheral surface adjacent to the opening portion, the outer peripheral surface formed in n-fold rotational symmetry,
the module comprises an outer peripheral wall corresponding to the outer peripheral surface, the outer peripheral wall formed in n-fold rotational symmetry, and
the mount configured to receive the module in n-fold rotational symmetry.

10. The apparatus of claim 7, wherein
the module is inserted between the case and the cover, and is fixed to the opening portion.

11. The apparatus of claim 10, wherein
the module comprises an outer peripheral wall between the case and the cover, the outer peripheral wall formed in n-fold rotational symmetry and in mirror symmetry.

12. The apparatus of claim 10, wherein
the case comprises an outer peripheral surface adjacent to the opening portion, the outer peripheral surface formed in n-fold rotational symmetry,
the module comprises an outer peripheral wall corresponding to the outer peripheral surface, the outer peripheral wall formed in n-fold rotational symmetry, and
the cover is attached to the mount to allow the module to be sandwiched in n-fold rotational symmetry between the case and the cover.
